(19) United States
(12) Patent Application Publication
(10) Pub. No.: US 2010/0106851 A1
(43) Pub. Date: Apr. 29, 2010

(54) CONTENT DELIVERY SYSTEM

(75) Inventors: Takashi Aoki, Kodaira (JP); Yoichi Okuyama, Fujimi (JP); Hiroto Kawachi, Fujima (JP); Takae Wakabayashi, Fujima (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/532,838

(22) PCT Filed: Mar. 29, 2007
(86) PCT No.: PCT/JP2007/056935

§ 371 Date: Sep. 24, 2009

(51) Int. Cl. G06F 15/16

(52) U.S. Cl. 709/231

(57) ABSTRACT

A content delivery system includes a content management element for managing one or more of contents, a multicast delivery element for delivering a multicast stream of the content or contents, a unicast delivery element for delivering a unicast stream of the content or contents, and a terminal. In response to a delivery request, the content management element transmits to the terminal, first information identifying the multicast delivery element and second information identifying the unicast delivery element. The terminal receives and reproduces a multicast stream corresponding to desired content according to the first information. When special reproduction is requested, the terminal requests the unicast delivery element to perform the special reproduction according to the second information. In response to the request for special reproduction, the unicast delivery element delivers the unicast stream for the special reproduction to the terminal. The terminal receives and reproduces the unicast stream for the special reproduction.

### TECHNICAL FIELD

The present invention relates to a content delivery system for delivering content such as films, drama, and animation by multicast or unicast.

### BACKGROUND ART

As this type of content delivery system, for example, there is a content delivery system provided with a multicast content server for providing the content by multicasting, which is a method of providing the same content by a plurality of lines or routes; a unicast content server for providing the content by unicast; and a service server for selecting a content delivery method. In the case of multicasting, the same content is delivered to a plurality of clients in parallel, so that its delivery efficiency is high. In contrast, in the case of unicast, it is individual delivery to an individual client, so that it is possible to respond to special reproduction such as fast-forward and rewind, which is individually desired from each client. On the other hand, if the number of clients is less than the number of lines provided for the multicast content server, the service server gives an instruction to unicast-deliver the content from a client which will start reception next, and if the number of clients is greater than the number of lines, the service server gives an instruction to multicast-deliver the content from the client which will start the reception next (refer to a patent document 1).

### Patent Document 1: Japanese Patent Application Laid Open No. 2002-353964

### DISCLOSURE OF INVENTION

### Subject to be Solved by the Invention

According to the aforementioned background art, however, the multicast and the unicast cannot be changed to each other during content watching, so that the client that receives the content by multicasting cannot perform the special reproduction, which is technically problematic.

In view of the aforementioned problems, it is therefore an object of the present invention to provide a content delivery system in which special reproduction can be performed during multicast content watching.

### Means for Solving the Subject

The above object of the present invention can be achieved by a first content delivery system provided with: a content managing device for managing one or a plurality of content; a multicast delivering device for delivering a multicast stream of the managed content; a unicast delivering device for delivering a unicast stream of the managed content; and a terminal capable of receiving and reproducing the delivered multicast stream and the delivered unicast stream and also capable of receiving a request for delivery of desired content and a request for special reproduction when the desired content is reproduced, the content managing device transmitting first information for specifying the multicast delivering device and second information for specifying the unicast delivering device to the terminal in response to the received request for delivery, the terminal receiving and reproducing the multicast stream corresponding to the desired content of the delivered multicast stream on the basis of the transmitted first information, the terminal requesting the special reproduction of the unicast delivering device on the basis of the transmitted second information when the request for the special reproduction is received, the unicast delivering device delivering the unicast stream for the special reproduction corresponding to the desired content, to the terminal in response to the request for the special reproduction, the terminal receiving and reproducing the delivered unicast stream for the special reproduction.

According to the first content delivery system of the present invention, the content managing device manages one or the plurality of content. Here, the “content” of the present invention typically means visual content such as films, drama, and animation, i.e. content with image information or video information; however, it may also include auditory content such as the Internet radio, i.e. content only with audio information.

The multicast delivering device typically delivers the multicast stream of the content in accordance with a predetermined time table. Here, the “multicast stream” of the present invention means a stream including data associated with the multicast-delivered content.

The unicast delivering device typically delivers the unicast stream of the content requested of the terminal in response to the request from the terminal. Here, the “unicast stream” of the present invention means a stream including the data associated with the unicast-delivered content.

The content managing device is typically disposed on a server apparatus different from those of the multicast delivering device and the unicast delivering device. The server apparatus equipped with the content managing device typically stores data (i.e. menu data) for displaying information such as a title, a maker, and a reproduction time about the content managed by the content managing device, as a list.

The multicast delivering device and the unicast delivering device may be disposed in respective different server apparatuses or the same server apparatus. The server apparatus provided with at least one of the multicast delivering device and the unicast delivering device stores content data.

For example, the terminal such as a two-way television and PC (Personal Computer) can receive and reproduce the delivered multicast stream and the delivered unicast stream and also can receive the request for the special reproduction when the delivery of the desired content is requested and the desired content is reproduced.

In operation, firstly, the server apparatus provided with the content managing device transmits the menu data to the terminal. When the content is selected by the user and the delivery of the selected content is requested from the terminal, the content managing device transmits the first information for specifying the multicast delivering device and the second information for specifying the unicast delivering device to the terminal. Here, the “first information” and the “second information” of the present invention mean the multicast address of the multicast delivering device and the unicast address of the unicast delivering device, respectively.

Incidentally, typically, only the server apparatus provided with the content managing device or, for example, URL (Uniform Resource Locator) which accesses the menu data stored in the server apparatus are open to the public, and the multicast address of the multicast delivering device and the unicast address of the unicast delivering device are not open.

Then, the terminal receives and reproduces the multicast stream corresponding to the desired content (i.e. the stream including the data of the selected content) of the delivered multicast stream, on the basis of the first information.

When the special reproduction is instructed from the user during the reproduction, the terminal requests the special reproduction of the unicast delivering device on the basis of the second information. Here, the “special reproduction” of the present invention means, for example, fast-forward, slow-motion play, frame-by-frame play, rewind, pause, reverse, and the like, except normal reproduction and stop.

Incidentally, the multicast delivering device typically delivers the information indicating the reproduction position of the content, with the information attached to the multicast stream. The terminal obtains the reproduction position of the reproduced multicast stream when the special reproduction is instructed, and the terminal requests the special reproduction from the obtained reproduction position. Here, the “reproduction position” of the present invention means an elapsed time from the head of the content. The reproduction position may be expressed by, for example, hour, minute, and second, or it may be expressed by a percentage, rate, or ratio of the entire content.

The unicast delivering device generates and delivers the unicast stream for the special reproduces to the terminal in response to the request for the special reproduction. The terminal reproduces the received unicast stream for the special reproduction.

If the content is only multicast-delivered, the delivery efficiency is extremely high because the content can be delivered to many terminals, simultaneously or in parallel; however, the special reproduction cannot be performed individually on the receiving terminal. On the other hand, if the content is only unicast-delivered, although the special reproduction can be performed, for example, the number of terminals that can watch the content is likely limited, or the cost is likely increased by providing many server apparatuses. In other words, the delivery efficiency is considerably low as a whole. Moreover, when the special reproduction is instructed from the user, if the terminal obtains the address or the like of the server for special reproduction again, it takes time to actually switch to the special reproduction after the instruction of the special reproduction, which likely brings discomfort or the like to the user.

In the present invention, however, when the delivery is requested from the terminal, the content managing device transmits the first information (i.e. the multicast address of the multicast delivering device) and the second information (i.e. the unicast address of the unicast delivering device which can be used in the special reproduction) in advance to the terminal.

By this, it is possible to perform the special reproduction while watching the multicast-delivered content. In addition, since the unicast address for the special reproduction is obtained in advance, it is possible to switch to the special reproduction, seamlessly. Here, “seamlessly” means that the streams are continued before and after the changing, to the extent that a viewer does not notice it. In other words, it means that a motion picture does not stop or that there is no transit to a standby screen before and after the stream changing. Moreover, since the rate of the number of terminals that request the special reproduction to the number of terminals that watch the content is predicted to be small, it is possible to limit or control the increase in cost caused by providing the server apparatus. In other words, the multicasting with a high delivery efficiency is used in the normal reproduction, and it is seamlessly changed to the unicast reproduction necessary for the special reproduction in the special reproduction, so that the same environment as using the unicast all the time (relatively expensive) is established from the standpoint of the viewer. In other words, it is possible to avoid establishing the overengineering environment that always uses the unicast which may be actually unnecessary or which is hardly necessary in some cases.

According to the present invention as described above, it is possible to perform the special reproduction while watching the multicast content.

In one aspect of the first content delivery system of the present invention, the terminal obtains a reproduction position of the multicast stream corresponding to the desired content when the request for the special reproduction is received, and the terminal requests the special reproduction from the obtained reproduction position of the unicast delivering device.

According to this aspect, when the request for the special reproduction is received, the terminal typically obtains the reproduction position of the reproduced multicast stream from the information indicating the reproduction position attached to the multicast stream. The terminal requests the special reproduction from the obtained reproduction position of the unicast delivering device.

Incidentally, if the multicast delivering device does not deliver the information indicating the reproduction position, with the information attached to the multicast stream, for example, the delivery start time point of the content may be obtained from the multicast delivering device, and a time difference between the delivery start time point and a current time point may be calculated, by which the reproduction time is obtained.

In another aspect of the first content delivery system of the present invention, the terminal stops the reception of the multicast stream corresponding to the desired content when the request for the special reproduction is received.

According to this aspect, for example, it is possible to reduce a load of a router which exists on a network and which is used by the terminal.

In another aspect of the first content delivery system of the present invention, the multicast delivering device and the unicast delivering device are disposed in respective different server apparatuses.

According to this aspect, it is possible to disperse loads of the server apparatuses.

In another aspect of the first content delivery system of the present invention, the multicast delivering device and the unicast delivering device are disposed in a same server apparatus.

According to this aspect, for example, there is no longer such a situation that the server is not used even if the special reproduction is not requested. Thus, it is possible to increase the rate of utilization of the server apparatus, and it is also possible to reduce costs and save space by determining the number of server apparatuses in consideration of the rate of utilization.

In this aspect, the unicast delivering device may deliver the multicast stream that can be received by a particular terminal as the unicast stream.

By virtue of such construction, it can be realized only by the channel changing operation without the terminal being aware of the unicast delivery, so that it is extremely useful in practice. Here, the expression “that can be received by the particular terminal” means “that can be received by only one particular terminal”. Although the delivery is performed by using the multicast stream, it is the same as the delivery by using the unicast stream in practice.

The above object of the present invention can be also achieved by a second content delivery system provided with: a content managing device for managing one or a plurality of content; a multicast delivering device for delivering a multicast stream of the managed content; a unicast delivering device for delivering a unicast stream of the managed content; a terminal capable of receiving and reproducing the delivered multicast stream and the delivered unicast stream and also capable of receiving a request for delivery of desired content and a request for special reproduction when the desired content is reproduced; and a router for relaying the terminal to each of the content managing device, the multicast delivering device, and the unicast delivering device, the content managing device transmitting first information for specifying the multicast delivering device and second information for specifying the unicast delivering device to the router in response to the received request for delivery, the router transmitting the multicast stream corresponding to the desired content of the delivered multicast stream, to the terminal on the basis of the transmitted first information, the terminal receiving and reproducing the transmitted multicast stream, the terminal requesting the special reproduction of the router when the request for the special reproduction is received, the router requesting the special reproduction of the unicast delivering device on the basis of the delivered second information when the special reproduction is requested, the unicast delivering device delivering the unicast stream for the special reproduction corresponding to the desired content, to the router in response to the request for the special reproduction, the router transmitting the delivered unicast stream for the special reproduction to the terminal, the terminal receiving and reproducing the transmitted unicast stream for the special reproduction.

According to the second content delivery system of the present invention, the router corresponds to multicasting, and the router relays the terminal to each of the content managing device, the multicast delivering device, and the unicast delivering device.

Firstly, when the content is selected by the user and the delivery of the selected content is requested from the terminal, the content managing device transmits the first information for specifying the multicast delivering device and the second information for specifying the unicast delivering device, to the router. Typically, the router transmits only the received first information to the terminal. Then, if the terminal requests the delivery of the selected multicast stream of the router on the basis of the received first information, the router transmits the multicast stream corresponding to the desired content of the delivered multicast stream to the terminal on the basis of the first information.

When the special reproduction is requested from the terminal during the reproduction, the router requests the special reproduction of the unicast delivering device on the basis of the second information. The unicast delivering device generates and delivers the unicast stream for the special reproduction to the router in response to the request for the special reproduction. The router changes information about the received unicast stream for the special reproduction; for example, specifically, the router changes the second information indicating the unicast delivering device which is a source to the first information indicating the multicast delivering device and changes the destination to the terminal, thereby transmitting it to the terminal as the multicast stream.

By this, it is possible to perform the special reproduction while watching the content multicast-delivered. In addition, since the router obtains the unicast address in advance, it is possible to switch to the special reproduction seamlessly. Moreover, since the switch from the multicast delivery to the special reproduction (i.e. the unicast delivery) is performed by the router, it is possible to reduce a load of the terminal.

In one aspect of the second content delivery system of the present invention, the router transmits the delivered unicast stream for the special reproduction to the terminal as the multicast stream.

According to this aspect, the router changes information about the unicast stream for the special reproduction (specifically, an IP (Internet Protocol) address and a hardware address included in a packet) and transmits it to the terminal as the multicast stream.

In another aspect of the second content delivery system of the present invention, the router transmits the transmitted first information to the terminal.

According to this aspect, since the router transmits only the first information to the terminal, the terminal does not need the channel changing operation.

In another aspect of the first content delivery system of the present invention, the terminal can also receive a request for return to normal reproduction when the special reproduction is performed on the desired content, the terminal requests the return of the unicast delivering device on the basis of the transmitted second information when the request for the return is received, the unicast delivering device includes a judging device for judging whether or not there is the multicast stream for the return at a reproduction position in a predetermined period with respect to a reproduction position of the unicast stream for the special reproduction when the return is requested, the unicast delivering device transmits a time difference between the reproduction positions of the unicast stream for the special reproduction and the multicast stream for the return to the terminal and delivers the unicast stream for the normal reproduction from the reproduction position of the unicast stream for the special reproduction if it is judged that there is the multicast stream for the return, the terminal receives and reproduces the unicast stream for the normal reproduction delivered such that the time difference is eliminated, and the terminal receives and reproduces the multicast stream for the return under a condition that the time difference is eliminated.

According to this aspect, the terminal can receive the request for the return to the normal reproduction when the special reproduction is performed on the desired content. The terminal requests the return of the unicast delivering device on the basis of the second information when the request for the return is received.

The judging device judges whether or not there is the multicast stream for the return at the reproduction position in the predetermined period with respect to the reproduction position of the unicast stream for the special reproduction when the return is requested. Here, the “predetermined period” of the present invention is a value for determining whether or not there is the multicast stream for the return. It is typically set as a fixed value in advance, but it may be set a variable value according to some parameters. The predetermined period is, for example, several seconds, and it is set as a period which does not bring discomfort to the user when a returning process described later is performed.

If it is judged that there is the multicast stream for the return, the unicast delivering device transmits the time difference between the reproduction positions of the unicast stream for the special reproduction and the mutilcast stream for the return, to the terminal, and the unicast delivering device delivers the unicast stream for the normal reproduction from the reproduction position of the unicast stream for the special reproduction. Here, the “reproduction position of the unicast stream for the special reproduction” means the “reproduction position of the unicast stream for the special reproduction when the normal reproduction is requested”.

The terminal performs the returning process on the delivered unicast stream for the normal reproduction and reproduces it such that the time difference is eliminated. Specifically, for example, if the multicast stream for the return is delayed, the number of frames of the unicast stream for the normal reproduction is increased or the like so that the time difference is eliminated.

Next, the terminal receives and reproduces the multicast stream for the return under the condition that the time difference is eliminated.

On the other hand, if it is judged that there is no multicast stream for the return, the unicast delivering device typically delivers the unicast stream for the normal reproduction from the reproduction position of the unicast stream for the special reproduction, to the terminal.

By this, it is possible to return to the multicast delivery again after the switch to the unicast delivery, thereby reducing a load of the unicast delivering device.

In another aspect of the second content delivery system of the present invention, the terminal can also receive a request for return to normal reproduction when the special reproduction is performed on the desired content, the terminal requests the return of the router when the request for the return is received, the router requests the return of the unicast delivering device on the basis of the delivered second information when the return is requested, the unicast delivering device includes a judging device for judging whether or not there is the multicast stream for the return at a reproduction position in a predetermined period with respect to a reproduction position of the unicast stream for the special reproduction when the return is requested, the unicast delivering device transmits a time difference between the reproduction positions of the unicast stream for the special reproduction and the multicast stream for the return to the router and delivers the unicast stream for the normal reproduction from the reproduction position of the unicast stream for the special reproduction if it is judged that there is the multicast stream for the return, the router transmits the unicast stream for the normal reproduction to the terminal such that the time difference is eliminated, the terminal receives and reproduces the transmitted unicast stream for the normal reproduction, the router transmits the multicast stream for the return, to the terminal under a condition that the time difference is eliminated, and the terminal receives and reproduces the transmitted multicast stream for the return.

According to this aspect, if it is judged that there is the multicast stream for the return, the unicast delivering device transmits the time difference between the reproduction positions of the unicast stream for the special reproduction and the multicast stream for the return, to the router, and the unicast delivering device also delivers the unicast stream for the normal reproduction from the reproduction position of the unicast stream for the special reproduction.

The router performs the returning process on the delivered unicast stream for the normal reproduction such the time difference is eliminated, before transmitting it to the terminal. Then, the router transmits the multicast stream for the return, to the terminal under the condition that the time difference is eliminated.

On the other hand, if it is judged that there is no multicast stream for the return, the unicast delivering device typically delivers the unicast stream for the normal reproduction from the reproduction position of the unicast stream for the special reproduction, to the router.

By this, it is possible to return to the multicast delivery again after the switch to the unicast delivery, thereby reducing the load of the unicast delivering device. Moreover, since the return to the multicast delivery is performed by the router, it is possible to reduce the load of the terminal.

In another aspect of the first content delivery system of the present invention, the terminal can also receive a request for return to normal reproduction when the special reproduction is performed on the desired content, the terminal requests the return of the unicast delivering device on the basis of the transmitted second information when the request for the return is received, the unicast delivering device includes a judging device for judging whether or not there are a predetermined number or more of unicast streams at reproduction positions in a predetermined period with respect to a reproduction position of the unicast stream for the special reproduction when the return is requested, the unicast delivering device requests the multicast delivering device to generate the multicast stream for the return if it is judged that there are the predetermined number or more of unicast streams, also transmits a time difference between the reproduction positions of the unicast stream for the special reproduction and the multicast stream for the return, to the terminal, and delivers the unicast stream for the normal reproduction from the reproduction position of the unicast stream for the special reproduction, the terminal receives and reproduces the unicast stream for the normal reproduction delivered such that the time difference is eliminated, the terminal receives and reproduces the multicast stream for the return under a condition that the time difference is eliminated.

According to this aspect, the judging device judges whether or not there are the predetermined number or more of unicast streams at the reproduction positions in the predetermined period with respect to the reproduction position of the unicast stream for the special reproduction when the return is requested.

Here, the “predetermined number” of the present invention is a value for determining whether or not the multicast delivering device is requested to generate the multicast stream for the return, and it is set as a fixed value in advance or a variable value according to some parameters. The predetermined number is typically set in accordance with the capacity of the unicast delivering device (e.g. the number of unicast streams which can be delivered simultaneously, or the like).

If there are the predetermined number or more of unicast streams, the unicast delivering device requests the multicast delivering device to generate the multicast stream for the return. Moreover, the unicast delivering device transmits the time difference between the reproduction positions of the unicast stream for the special reproduction and the multicast stream for the return, to the terminal, and the unicast delivering device also delivers the unicast stream for the normal reproduction from the reproduction position of the unicast stream for the special reproduction.

The terminal performs the returning process on the unicast stream for the normal reproduction such that the time difference is eliminated, and reproduces it. The terminal receives and reproduces the multicast stream for the return under the condition that the time difference is eliminated.

On the other hand, if it is judged that there are no predetermined number or more of unicast streams, the unicast delivering device typically delivers the unicast stream for the normal reproduction from the reproduction position of the unicast stream for the special reproduction, to the terminal. Incidentally, even in this case, later, when the number of unicast streams at the reproduction positions in the predetermined period is greater than or equal to the predetermined number, the unicast delivering device requests the multicast delivering device to generate the multicast stream for the return.

By this, when the return from the special reproduction to the normal reproduction is requested from the terminal, even if there is no delivered multicast stream for the return, it is possible to return to the multicast delivery by generating a new multicast stream for the return.

The operation and other advantages of the present invention will become more apparent from the embodiments explained below.

### BRIEF DESCRIPTION OF DRAWINGS

FIG. 1 is a schematic diagram showing the structure of a content delivery system in a first embodiment.

FIG. 2 is a block diagram showing the structure of a multicast server in the first embodiment.

FIG. 3 is a conceptual view showing one example of a management data table in the multicast server in the first embodiment.

FIG. 4 is a block diagram showing a unicast server in the first embodiment.

FIG. 5 is a conceptual view showing one example of a management data table in the unicast server in the first embodiment.

FIG. 6 is a block diagram showing the structure of a menu server in the first embodiment.

FIG. 7 is a conceptual view showing one example of a content information table in the first embodiment.

FIG. 8 is a block diagram showing the structure of a multicast-enabled router in the first embodiment.

FIG. 9 is a conceptual view showing one example of a MAC address table in the first embodiment.

FIG. 10 is a block diagram showing the structure of a client 60 in the first embodiment.

FIG. 11 is a timing chart showing a process of changing from multicast delivery to unicast delivery in the content delivery system in the first embodiment.

FIG. 12 is a timing chart showing a process of returning to the multicast delivery in the content delivery system in the first embodiment.

FIG. 13 is a schematic diagram showing the structure of a content delivery system in a second embodiment.

FIG. 14 is a block diagram showing the structure of a multicast server in the second embodiment.

FIG. 15 is a conceptual view showing one example of a management data table in the multicast server in the second embodiment.

FIG. 16 is a conceptual view showing one example of a content information table in the second embodiment.

FIG. 17 is a timing chart showing a process of changing from multicast delivery to substantial unicast delivery in the content delivery system in the second embodiment.

FIG. 18 is a timing chart showing a process of returning to the multicast delivery in the content delivery system in the second embodiment.

FIG. 19 is a timing chart showing a process of changing from multicast delivery to substantial unicast delivery in a content delivery system in a third embodiment.

FIG. 20 is a timing chart showing a process of returning to the multicast delivery in the content delivery system in the third embodiment.

FIG. 21 is a timing chart showing a process of returning to multicast delivery in a content delivery system in a fourth embodiment.

### DESCRIPTION OF REFERENCE CODES

1, 2 content delivery system
10 network
20, 25 multicast server
30 unicast server
40, 45 menu server
50 router
60 client
70 user

### BEST MODE FOR CARRYING OUT THE INVENTION

Hereinafter, embodiments of the content delivery system of the present invention will be described with reference to the drawings.

### First Embodiment

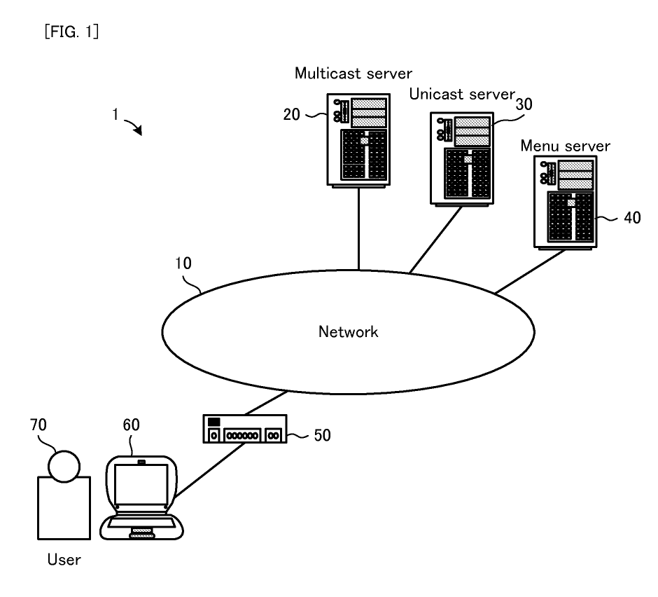

A first embodiment of the delivery system of the present invention will be described with reference to FIG. 1 to FIG. 12.

(Structure of Content Delivery System)

Firstly, the structure of the content delivery system in the embodiment will be explained with reference to FIG. 1. FIG. 1 is a schematic diagram showing the structure of the content delivery system in the first embodiment. Incidentally, in FIG. 1, a content delivery system 1 is typically provided with a plurality of clients; however, for convenience of explanation, only one client 60 of the plurality of clients is shown. Moreover, the content delivery system 1 is provided with a plurality of routers; however, for convenience of explanation, only a route 50 of the plurality of routers which is closest to the client 60 is shown.

In FIG. 1, the content delivery system 1 is provided with a multicast server 20, a unicast server 30, a menu server 40, a router 50, and a client 60. The “multicast server 20”, the “unicast server 30”, the “menu server 40”, and the “client 60” in the embodiment are the “multicast delivering device”, the “unicast delivering device”, the “content managing device”, and the “terminal” in the present invention, respectively.

Incidentally, the content delivery system 1 may be provided with a plurality of multicast servers 20 and a plurality of unicast servers 30.

The client 60 is connected to the router 50 which is a router corresponding to multicasting, through a LAN (Local Area Network) cable, a wireless communication unit having a predetermined wireless communication band, or the like. The router 50 is connected to each of the multicast server 20, the unicast server 30, and the menu server 40, through the network 10 which is a wide area network such as the Internet.

The multicast server 20 typically generates and automatically delivers a multicast stream of predetermined content data in accordance with a predetermined time table. The unicast server 30 typically generates and delivers a unicast stream of the relevant content data in accordance with a delivery request from the client 60.

The menu server 40 manages at least one or a plurality of content data stored by each of the multicast server 20 and the unicast server 30. Typically, the menu server 40 also has a function of a portal server for providing a user 70 with a menu image for content selection.

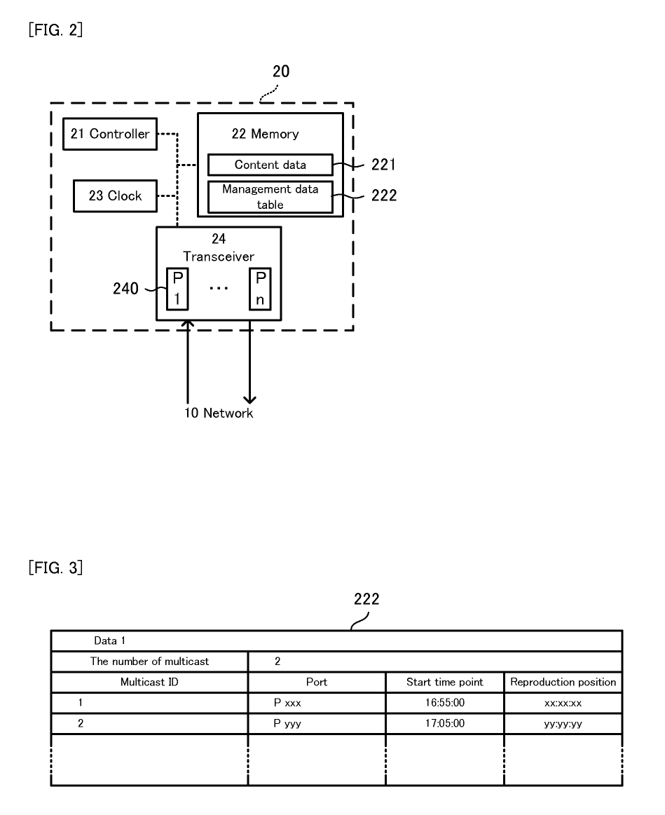

Next, with reference to FIG. 2 and FIG. 3, the multicast server 20 will be explained. FIG. 2 is a block diagram showing the structure of the multicast server 20.

In FIG. 2, the multicast server 20 is provided with a controller 21, a memory 22, a system clock 23, and a transceiver 24. The transceiver 24 has a plurality of ports 240 which can be used for data transmission and reception.

The memory 22 stores content data 221 and a management data table 222 for managing delivering content, as shown in FIG. 3. FIG. 3 is a conceptual view showing one example of the management data table in the multicast server 20 in the first embodiment.

The management data table 222 is typically provided for each content and stores, for example, the number of delivering multicast streams, a port number used for the delivery, a time point to start the delivery, a reproduction position, or the like.

Incidentally, one or a plurality of content data 221 may be stored in the memory 22.

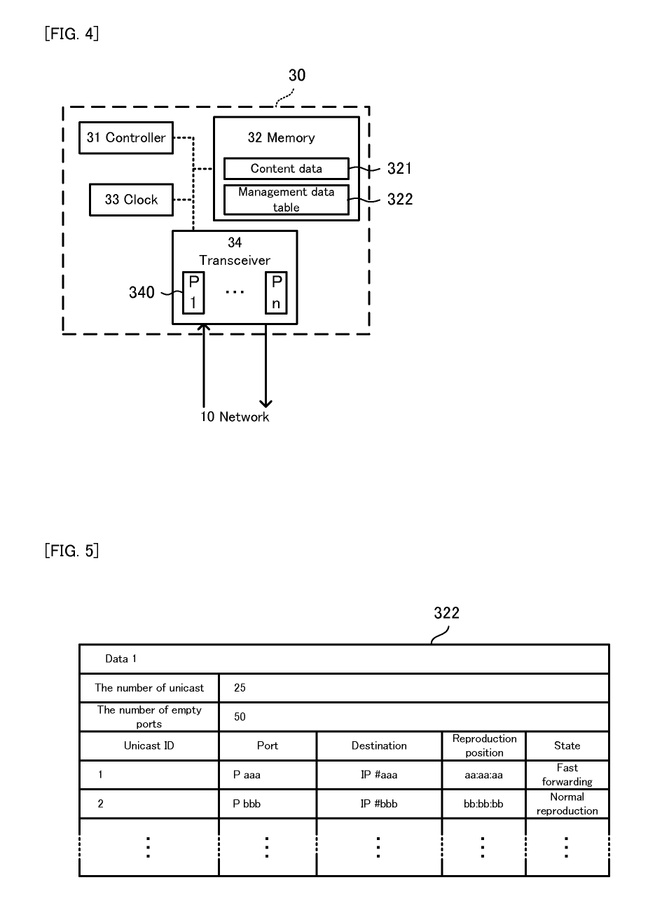

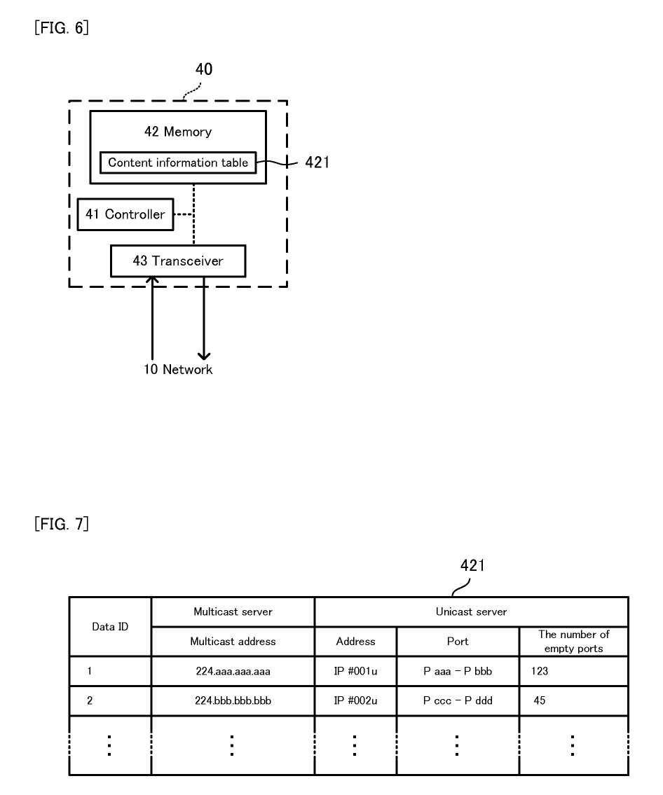

Next, with reference to FIG. 4 and FIG. 5, the unicast server 30 will be explained. FIG. 4 is a block diagram showing the structure of the unicast server 30.

In FIG. 4, the unicast server 30 is provided with a controller 31 as one example of the “judging device” of the present invention, a memory 32, a system clock 33, and a transceiver 34. The transceiver 34 has a plurality of ports 340 which can be used for data transmission and reception.

The memory 32 stores content data 321 and a management data table 322 for managing delivering content, as shown in FIG. 5. FIG. 5 is a conceptual view showing one example of the management data table in the unicast server 30 in the first embodiment.

The management data table 322 is typically provided for each content and stores, for example, the number of delivering unicast streams, a port number used for the delivery, a time point to start the delivery, a reproduction position, or the like.

Incidentally, one or a plurality of content data 321 may be stored in the memory 32. At least, the content data 321 includes the same content data as the content data 221 stored in the multicast server 20.

Next, with reference to FIG. 6 and FIG. 7, the menu server 40 will be explained. FIG. 6 is a block diagram showing the structure of the menu server 40.

In FIG. 6, the menu server 40 is provided with a controller 41, a memory 42, and a transceiver 43.

The memory 42 stores a content information table 421 for managing the content data 221 and 321 stored in the multicast server 20 and the unicast server 30, respectively, as shown in FIG. 7. FIG. 7 is a conceptual view showing one example of the content information table in the first embodiment.

The content information table 421 stores, for example, the multicast address of the multicast server 20 and the unicast address of the unicast server 30, a port number which can be used, and the number of empty ports, or the like, for each content.

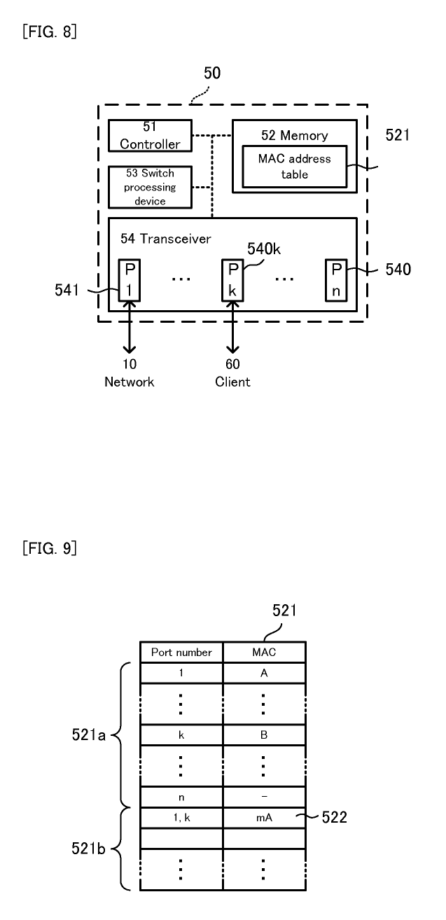

Next, with reference to FIG. 8 and FIG. 9, the router 50 will be explained. FIG. 8 is a block diagram showing the structure of the router 50.

In FIG. 8, the router 50 is provided with a controller 51, a memory 52, a switch processing device 53, and a transceiver 54. The transceiver 54 has a plurality of ports 540 which can be used for data transmission and reception.

The memory 52 stores a MAC (Media Access Control) address table 521 for identifying an apparatus which uses each port, as shown in FIG. 9. The MAC address table 521 is provided with a unicast communication area 521a and a multicast communication area 521b. FIG. 9 is a conceptual view showing one example of the MAC address table 521.

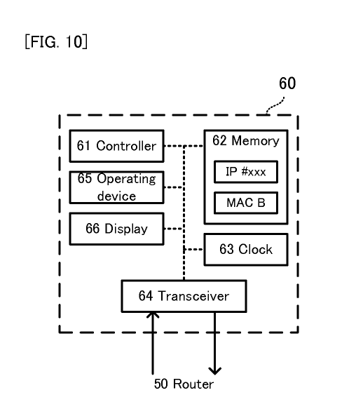

Next, with reference to FIG. 10, the client 60 will be explained. FIG. 10 is a block diagram showing the structure of the client 60.

In FIG. 10, the client 60 is provided with a controller 61, a memory 62, a system clock 63, a transceiver 64, an operating device 65, and a display 66.

The memory 62 stores an IP address of the client 60 and a MAC address. The memory 62 also stores application software or the like for receiving stream data such as video and audio delivered through the network 10 and for reproducing the received stream data.

Incidentally, the client 60 can also always hold the content data, which is received by virtue of the buffering function of the transceiver 64 or the buffering function of another exclusive buffer or a memory for temporal storage, for a certain degree of display time. By this, even if it takes some time for a changing process operation, it is easy to seamlessly perform the changing process operation.

(Changing Process Operation)

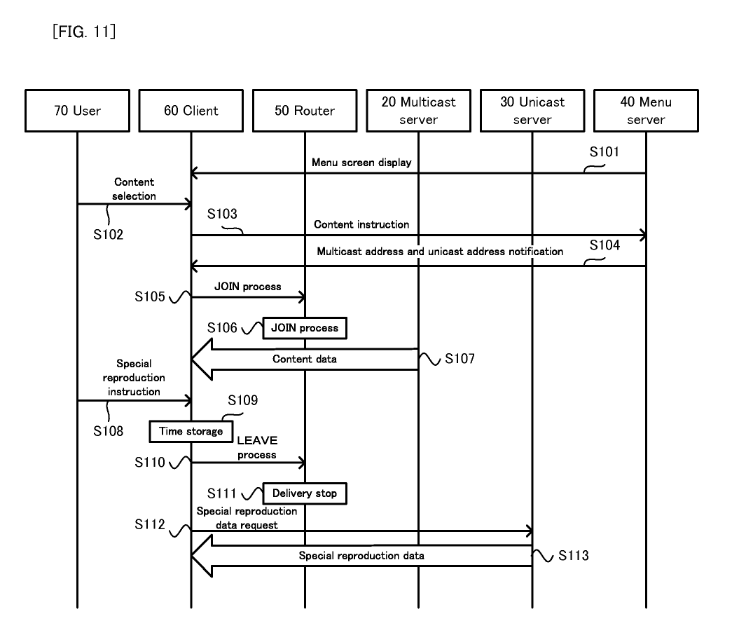

Next, an explanation will be given on the operation of the content delivery system 1 if the user 70 watches the content by using the content delivery system 1 as constructed above, with reference to a timing chart in FIG. 11.

In FIG. 11, firstly, when the user 70 uses the client 60 and accesses the menu server 40 through the network 10, the menu server 40 transmits menu data to the client 60, wherein the menu data is for displaying information as a list, such as a title, a reproduction time length, and a production company, about the content stored in the content management table 421 (step S101).

The controller 61 of the client 60 displays a predetermined menu image on the display 66 such as a LCD (Liquid Crystal Display) and a CRT (Cathode Ray Tube) on the basis of the received menu data.

If the user 70 selects the content with reference to the displayed menu image and gives an instruction to the client 60 by using the operating device 65 such as an operation button, a remote controller, a mouse, and a keyboard (step S102), the client 60 transmits a signal indicating the selected content to the menu server 40 (step S103).

The menu server 40 follows the received signal and transmits at least a signal indicating the multicast address of the multicast server 20 which delivers the selected content and a signal indicating the unicast address of the unicast server 30 which can be used when the user 70 performs the special reproduction, on the basis of the content information table 421 (step S104). Here, the “multicast address of the multicast server 20 which delivers the selected content” is one example of the “first information”, and the “unicast address of the unicast server 30 which can be used when the user 70 performs the special reproduction” is one example of the “second information”.

Incidentally, the menu server 40 typically recognizes the total number of ports which can be used for the delivery of the unicast stream in the unicast server 30 (or the total number of unicast streams that can be delivered).

If the menu server 40 specifies the port used by the client 60 when transmitting the signal indicating the address of the unicast server 30 to the client 60, the menu server 40 also transmits a signal indicating the specified port number to the client 60. In this case, the menu server 40 reduces the number of empty ports of the unicast server 30 (i.e. reduces the number of ports specified from the total number of the ports which can be used), regardless of whether or not the client 60 uses the port specified by the special reproduction or the like.

On the other hand, if the menu server 40 does not specify the port used by the client 60, when a request for the special reproduction or the like is given to the unicast server 30 from the client 60 or the like, the unicast server 30 distributes it to the port that is not used, and the unicast server 30 sequentially transmits a signal indicating the number of ports that are actually used or the number of ports that are not used, to the menu server 40.

Incidentally, if there are a plurality of multicast servers 20 or unicast servers 30 for delivering the selected content, the menu server 40 may transmit, for example, the signal indicating the address or the like of the multicast server 20 or the unicast serve 30 which is disposed closest to where the client 60 is disposed.

Next, the client 60 stores the received multicast address of the multicast server 20 and the received address of the unicast server 30 into the memory 62 and transmits a signal indicating a multicast participation report message for participating in a group that can receive the selected content, to the router 50 (step S105). The controller 51 of the router which has received the signal stores the number of a port 540k used by the client 60, the number of a port 521 used for the communication with the network 10, and the MAC address based on the relevant multicast address into the multicast communication area 521b of the MAC address table 521 stored in the memory 52, thereby enabling the client 60 to participate in the group that can receive the selected content (step S106).

Next, the switch processing device 53 transmits the multicast stream received from the multicast server 20 to the port 540k used by the client 60, on the basis of the MAC address table 521. The controller 61 of the client 60 reproduces the received multicast stream and displays it on the display 66 (step S107).

Incidentally, the multicast server 20 typically delivers information indicating the content reproduction position, with the information attached to the multicast stream.

If the user 70 gives an instruction of the special reproduction such as fast-forward and pause to the client 60 during content reproduction (step S108), the controller 61 stores the reproduction position of the multicast stream currently reproduced into the memory 62 (step S109).

Incidentally, if the multicast server 20 does not deliver the information indicating the reproduction position attached to the multicast stream, for example, when the client 60 participates in the group or when the special reproduction is instructed, the reproduction position may be obtained from the multicast server 20. Alternatively, a delivery start time point of the content is obtained from the multicast server 20, and a current time point is obtained from the system clock 63, and the reproduction time may be obtained by calculating their time difference.

Then, the client 60 transmits a signal indicating a multicast separation report message for separating from the group that can receive the selected content, to the router 50 (step S110). The controller 51 of the router 50 which has received the signal deletes the number of the port 540k used by the client 60 or the like from the multicast communication area 521b of the MAC address table 521 and stops the delivery of the multicast stream to the client 60 (step S111).

The client 60 transmits a signal for requesting the unicast stream for special reproduction, instructed from the reproduction position stored in the memory 62, to the unicast server 30, on the basis of the address of the unicast server 30 stored in the memory 62 in parallel with the transmission of the signal indicating the message (step S112).

The controller 31 of the unicast server 30 which has received the signal generates the requested unicast stream for special reproduction from the content data 321 stored in the memory 32, delivers it to the client 60, and updates the management data table 322 (step S113). The controller 61 of the client 60 reproduces the received unicast stream and displays it on the display 66.

By this, it is possible to perform the special reproduction while watching the content that is delivered by multicasting. In addition, since the unicast address is obtained in advance, it is possible to switch to the special reproduction, seamlessly.

(Returning Process Operation)

If the user 70 requests the client 60 to switch from the special reproduction to the normal reproduction, the unicast stream for normal reproduction can be received from the unicast server 30. However, in order to reduce a load of the unicast server 30 or the like, it is desirable to receive the multicast-delivered multicast stream, if possible.

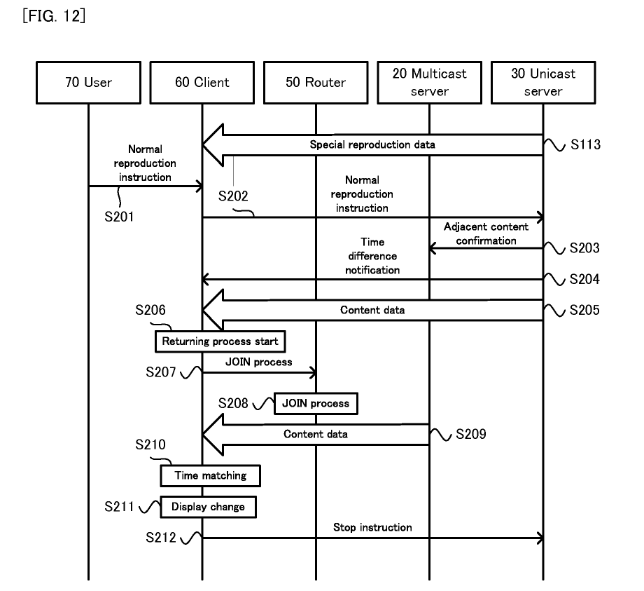

With reference to a timing chart in FIG. 12, an explanation will be given on a returning process operation of returning to the multicast delivery in the content delivery system 1 in the embodiment.

In FIG. 12, when the special reproduction is performed on the content (step S113), if the user 70 gives an instruction of the normal reproduction to the client 60 (step S201), the client 60 transmits a signal for requesting the normal reproduction, to the unicast serve 30 (step S202).

The unicast server 30 which has received the signal judges whether or not there is the multicast stream at the reproduction position in which the time difference from the reproduction position of the unicast stream delivered to the client 60 is within a predetermined time difference (e.g. several seconds) (which is hereinafter referred to adjacent content), in the multicast stream of the same content delivered by the multicast server 20 (step S203). The “adjacent content” in the embodiment is one example of the “multicast stream for return” of the present invention.

Specifically, the controller 31 of the unicast server 30 obtains the reproduction position of the multicast stream of the same content delivered, from the management data table 222 stored in the memory 22 of the multicast server 20. The controller 31 also compares the obtained reproduction position with the reproduction position of the unicast stream stored in the management data table 322 and delivered to the client 60, thereby judging whether or not their time difference is within the predetermined time difference.

Incidentally, when the unicast server 30 judges whether or not there is the adjacent content, if there are a plurality of multicast servers, it may be judged whether or not there is the adjacent content, with respect to the plurality of multicast servers. Alternatively, for example, like NVDO (Near Video On Demand), if the multicast server 20 delivers the multicast stream of the same content by using a plurality of ports 240 at different times, it may be judged whether or not there is the adjacent content, with respect to only one multicast server 20.

If it is judged that there is the adjacent content, the unicast server 30 transmits signals indicating the time difference from the adjacent content and the multicast address at which the adjacent content can be received, to the client 60 (step S204), and the unicast server 30 also generates the unicast stream for normal reproduction, delivers it to the client 60, and updates the management data table 322 (step S205).

On the other hand, if it is judged that there is no adjacent content, the unicast server 30 typically generates the unicast stream for normal reproduction, delivers it to the client 60, and updates the management data table 322.

The controller 61 of the client 60 which has received the signals indicating the time difference and the multicast address since it is judged that there is the adjacent content stores the received time difference and the received multicast address into the memory 62, and the controller 61 also performs a predetermined returning process on the unicast stream such that the time difference between the adjacent content and the received unicast stream is eliminated (step S206). Specifically, for example, if the adjacent content is behind the unicast stream, the controller 61 increases the number of frames of the unicast stream or performs similar actions to eliminate the time difference.

In parallel with the retuning process, the client 60 transmits the signal indicating the multicast participation report message to the router 50 (step S207). The router 50 which has received the signal enables the client 60 to participate in the group that can receive the adjacent content (step S208), so that the adjacent content is delivered to the client 60 from the multicast server 20 (step S209).

If it is judged that the time difference between the adjacent content and the unicast stream is eliminated (step S210), the controller 61 of the client 60 reproduces the adjacent content and displays it on the display 66 (step S211).

Then, the client 60 transmits a signal indicating the stop of the delivery of the unicast stream, to the unicast server 30 (step S212).

By this, it is possible to return to the multicast delivery again after the special reproduction, thereby reducing the load of the unicast server 30.

### Second Embodiment

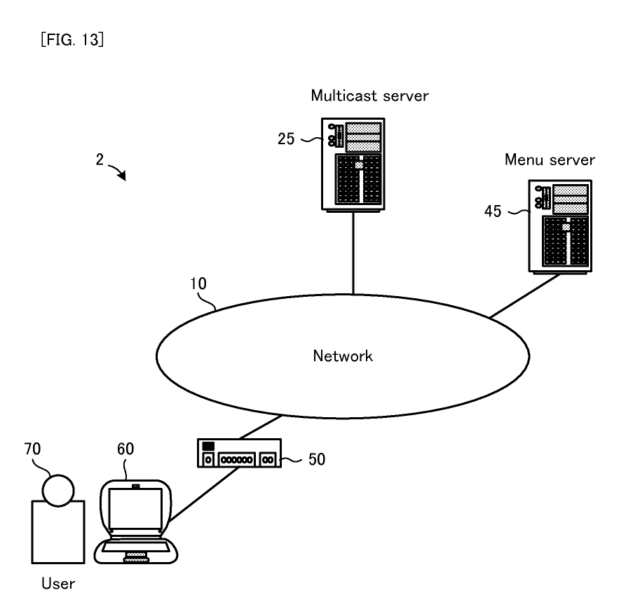

A second embodiment of the content delivery system of the present invention will be explained with reference to FIG. 13 to FIG. 18. The second embodiment has the same construction as the first embodiment, apart from the multicast server functioning as the unicast server. Thus, in the second embodiment, the repetitive explanation to the first embodiment will be omitted. Common points on the drawings will carry the same referential numerical, and basically different points will be explained with reference to FIG. 13 to FIG. 18. FIG. 13 is a schematic diagram showing the structure of a content delivery system in a second embodiment, to the effect of FIG. 1.

In FIG. 13, a content delivery system 2 is provided with a multicast server 25, a menu server 45, a router 50, and a client 60. The “multicast server 25” in the embodiment is one example of the “multicast delivering device” and the “unicast delivering device” of the present invention. Moreover, the “controller 21” and the “menu server 45” in the embodiment are one example of the “judging device” and the “content managing device” of the present invention, respectively.

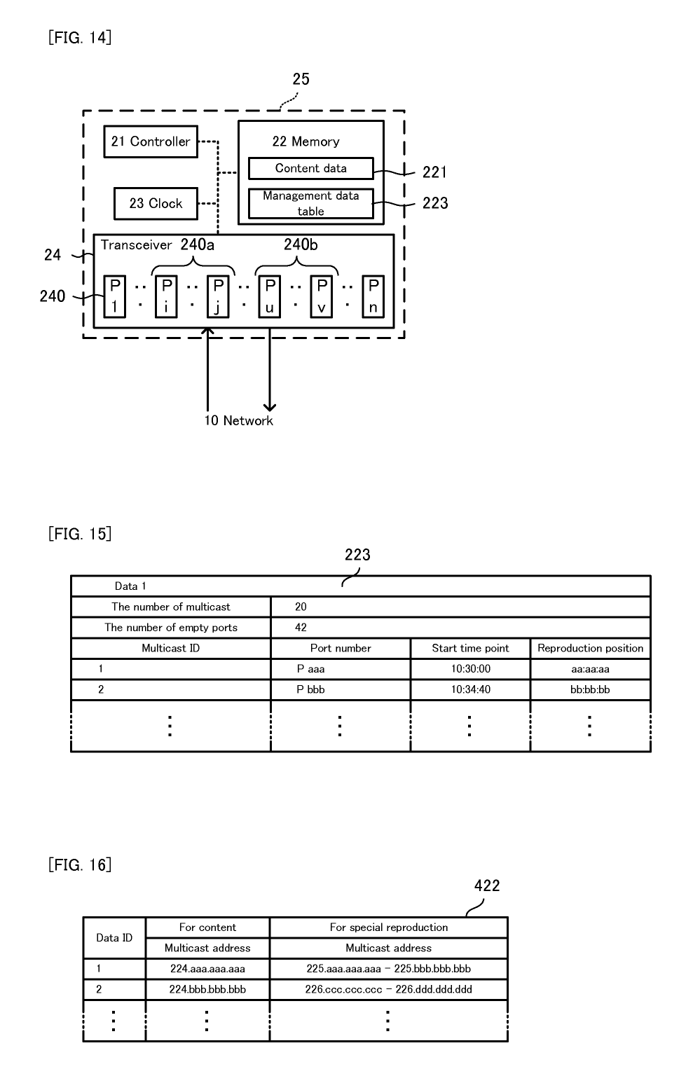

Here, the multicast server 25 will be explained with referenced to FIG. 14 and FIG. 15. FIG. 14 is a block diagram showing the structure of the multicast server 25 in the second embodiment.

In FIG. 14, the transceiver 24 has a plurality of ports 240 which can be used for data transmission and reception. One portion 240a of the plurality of ports 240 can be used for general multicast delivery, and another portion 240b can be used for multicast delivery to a particular destination (hereinafter referred to as for practical unicast delivery).

The memory 22 stores the content data 221 and a management data table 223 for managing delivering content, as shown in FIG. 15. FIG. 15 is a conceptual view showing one example of the management data table in the multicast server 25 in the second embodiment.

The management data table 223 is typically provided for each content and stores, for example, the number of delivering multicast streams, the number of empty ports, a port number used for the delivery, a time point to start the delivery, a reproduction position, or the like. Incidentally, the “number of empty ports” in the embodiment typically means the number of ports that are not used, in the port 240b which can be used for practical unicast delivery.

Next, the menu server 45 will be explained with reference to FIG. 16. The menu server 45 has the same structure as the menu server 40 in the first embodiment shown in FIG. 6, apart from having the different content of the content information table. FIG. 16 is a conceptual view showing one example of the content data table in the multicast server 45 in the second embodiment.

As shown in FIG. 15, a content information table 422 stores the multicast address for multicast delivery at which the content is multicast-delivered, the multicast address for practical unicast delivery at which the content is delivered as practical unicast delivery, and the like.

(Changing Process Operation)

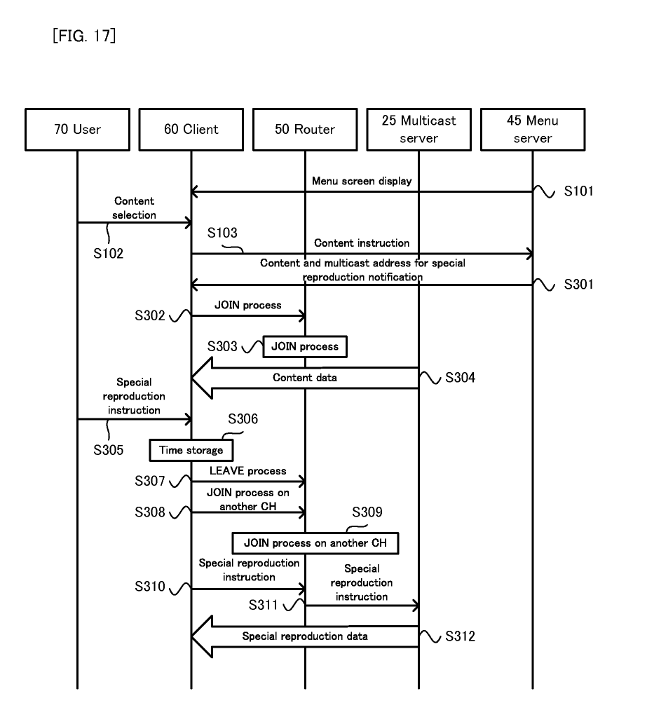

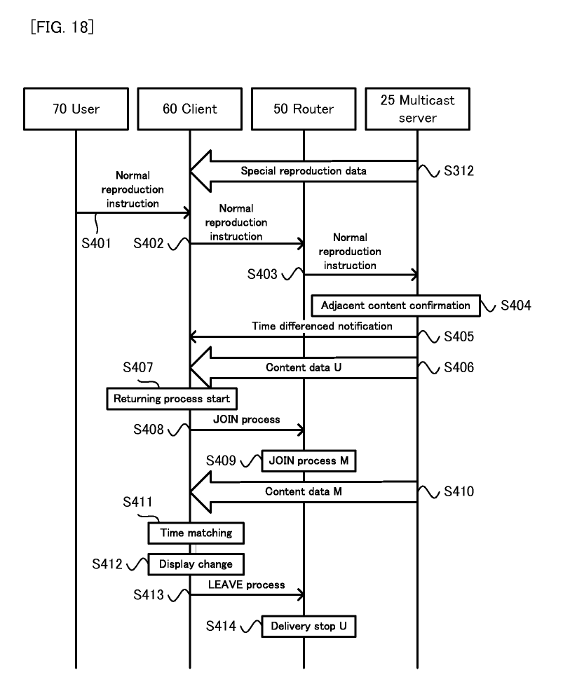

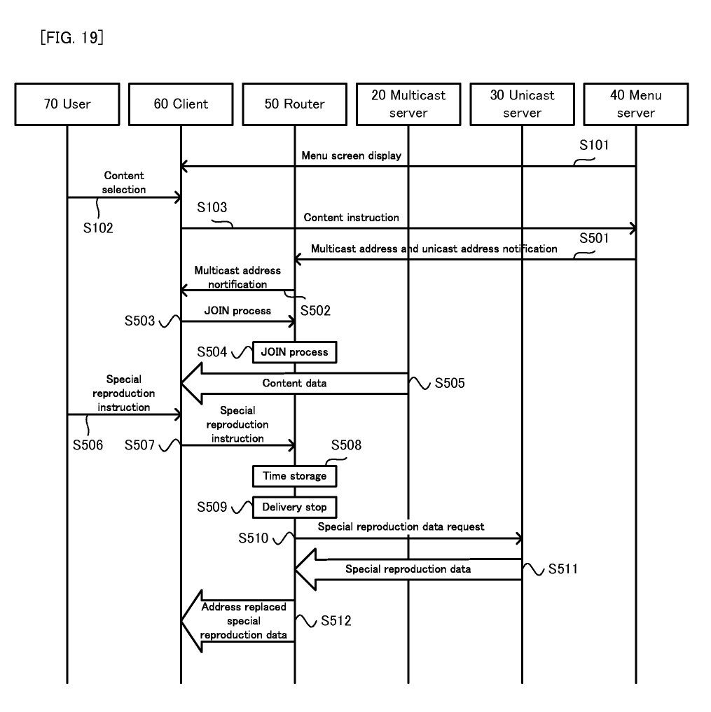

Next, the operation of the content delivery system 2 as constructed above will be explained with reference to a timing chart in FIG. 17.

In FIG. 17, the menu server 45 which has received the signal indicating the content selected by the user 70 and transmitted from the client 60 transmits at least the signal indicating the multicast address which can be used when the user 70 performs the special reproduction (hereinafter also referred to as a special reproduction multicast address), of the multicast address at which the selected content is delivered and the multicast address for practical unicast delivery, to the client 60 on the basis of the content information table 422 shown in FIG. 16 (step S301). Here, the “multicast address at which the selected content is delivered” and the “special reproduction multicast address” in the embodiment are one example of the “first information” and the “second information” of the present invention, respectively.

Next, the client 60 stores the received two multicast addresses in the memory 62 and transmits the signal indicating the multicast participation report message to the router 50 (step S302). The router 50 which has received the signal enables the client 60 to participate in the group that can receive the selected content (step S303). Then, the controller 61 of the client 60 reproduces the received multicast stream and displays it on the display 66 (step S304).

If the user 70 gives an instruction of the special reproduction to the client 60 during the content reproduction (step S305), the controller 61 stores the reproduction position of the multicast stream currently reproduced, into the memory 62 (step S306).

Then, the client 60 transmits the signal indicating the multicast separation report message (step S307) and transmits the signal indicating the multicast participation report message for receiving the stream from the special reproduction multicast address, on the basis of the special reproduction multicast address stored in the memory 62 (step S308).

The controller 51 of the router 50 deletes the MAC address stored at a predetermined position 522 in the multicast communication area 521b of the MAC address table 521 of the memory 52 shown in FIG. 9 and stores the MAC address based on the special reproduction multicast address (i.e. replaces the MAC address), thereby enabling the client 60 to participate in the group that can receive the stream from the special reproduction multicast address (step S309). Incidentally, the group is a group only for the user 70, and only the user 70 can participate therein. In other words, it is practically the unicast delivery.

The client 60 transmits the signal for requesting the stream for special reproduction, instructed from the reproduction position stored in the memory 62, to the router 50 in parallel with transmitting the signal indicating the aforementioned message (step S310). The router 50 which has received the signal transmits the same signal to the multicast server 25 (step S311).

The multicast server 25 which has received the signal generates the requested multicast stream for special reproduction and delivers it from the special reproduction multicast address, and updates the management data table 223 (step S312). The controller 61 of the client 60 reproduces the received multicast stream and displays it on the display 66.

By this, it is possible to perform the special reproduction while watching the content that is delivered by multicasting. In addition, since the unicast address is obtained in advance, it is possible to switch to the special reproduction, seamlessly. Moreover, it can be realized only by the channel changing operation without the client 60 being aware of the unicast delivery, so that it is extremely useful in practice.

Moreover, for example, there is no longer such a situation that the server is not used even if the special reproduction is not requested. Thus, it is possible to increase the rate of utilization of the server, and it is also possible to reduce costs and save space by reducing the number of servers in consideration of the rate of utilization.

(Returning Process Operation)

Next, with reference to a timing chart in FIG. 18, an explanation will be given on the returning process operation of returning to the general multicast delivery in the content delivery system 2 in the embodiment.

In FIG. 18, when the special reproduction is performed on the content (step S312), if the user 70 gives an instruction of the normal reproduction to the client 60 (step S401), the client 60 transmits the signal for requesting the stream for normal reproduction, to the router (step S402). The router 50 which has received the signal transmits the same signal to the multicast server 25 (step S403).

The controller 21 of the multicast server 25 which has received the signal judges whether or not there is adjacent content, on the basis of the management data table 223 stored in the memory 22 (step S404). Incidentally, if it is judged that there is no adjacent content in the multicast server 25, the controller 21 may judge that there is no adjacent content, or the controller 21 may also judge whether or not there is adjacent content with respect to another multicast server.

If it is judged that there is the adjacent content, the multicast server 25 transmits the signals indicating the time difference from the adjacent content and the multicast address at which the adjacent content can be received (step S405). The multicast server 25 also generates the multicast stream for normal reproduction and delivers it from the special reproduction multicast address, thereby updating the management data table 423 (step S406). Here, the “multicast stream for normal reproduction” in the embodiment is one example of the “unicast stream for normal reproduction” of the present invention.

On the other hand, if it is judged there is no adjacent content, the multicast server 25 typically generates the multicast stream for normal reproduction, delivers it from the special reproduction multicast address, and updates the management table 423.

The controller 61 of the client 60 which has received the signals indicating the time difference and the multicast address since it is judged that there is the adjacent content stores the received time difference and the received multicast address into the memory 62, and the controller 61 also performs a predetermined returning process on the multicast stream received from the special reproduction multicast address such that the time difference between the adjacent content and the multicast stream received from the special reproduction multicast address is eliminated (step S407).

In parallel with the retuning process, the client 60 transmits the signal indicating the multicast participation report message for receiving the stream from the multicast address of the adjacent content, to the router 50 (step S408). The controller 51 of the router 50 which has received the signal stores the port number and the MAC address based on the multicast address of the adjacent content at the position that is not used in the multicast communication area 521b of the MAC address table 521 shown in FIG. 9, thereby enabling the client 60 to participate in the group that can receive the stream from the multicast address of the adjacent content (step S409).

If it is judged that there is no time difference between the adjacent content and the multicast stream received from the special reproduction multicast address (step S411), the controller 61 of the client 60 reproduces the multicast stream from the multicast address of the adjacent content and displays it on the display 66 (step S412).

The client 60 transmits the signal indicating the multicast separation report message for separating from the group that can receive the stream from the special reproduction multicast address, to the router 50 (step S413). The controller 51 of the router 50 which has received the signal deletes the number of the port 540k used by the client 60 or the like from the predetermined position 522 in the multicast communication area 521b of the MAC address table 521 and stops the delivery of the multicast stream to the client 60 from the special reproduction multicast address (step S414).

By this, it is possible to return to the multicast delivery again after the special reproduction.

### Third Embodiment

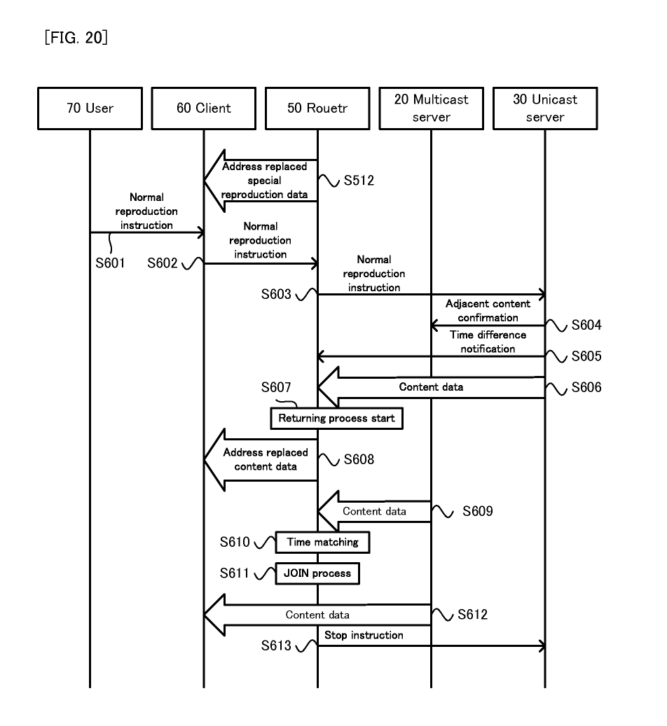

A third embodiment of the content delivery system of the present invention will be explained with reference to FIG. 19 and FIG. 20. The third embodiment has the same construction as that of the first embodiment, apart from having the different operation of the content delivery system. Thus, in the third embodiment, the repetitive explanation to the first embodiment will be omitted. Common points on the drawings will carry the same referential numerical, and basically different points will be explained with reference to FIG. 19 and FIG. 20.

(Changing Process Operation)

The operation of the content delivery system in the embodiment will be explained by using a timing chart in FIG. 19.

In FIG. 19, the menu server 40 which has received the signal which indicates the content selected by the user 70 and which is transmitted from the client 60 transmits at least the signals indicating the multicast address of the multicast server 20 which delivers the selected content and the unicast address of the unicast server 30 which can be used when the user 70 performs the special reproduction to the router 50 on the basis of the content information table 421 shown in FIG. 7 (step S501). The router 50 which has received the signal stores the received multicast address of the multicast server 20 and the received unicast address of the unicast server 30 and transmits only the signal indicating the multicast address to the client 60 (step S502).

Then, the client 60 stores the received multicast address into the memory 62 and also transmits the signal indicating the multicast participation report message for participating in the group that can receive the selected content, to the router 50 (step S503). The router 50 which has received the signal enables the client 60 to participate in the group that can receive the selected content (step S504). Then, the controller 61 of the client 60 reproduces the received multicast stream and displays it on the display 66 (step S505).

If the user 70 gives an instruction of the special reproduction to the client 60 during the content reproduction (step S506), the client 60 transmits the signal indicating the instructed special reproduction, to the router 50 (step S507). The controller 51 of the router 50 which has received the signal stores the reproduction position of the multicast stream received by the client 60, into the memory 52 (step S508).

Then, the controller 51 deletes the number of the port 540k used by the client 60 or the like from the multicast communication area 521b of the MAC address table 521 and stops the delivery of the multicast stream to the client 60 (step S509).

Incidentally, if there is another client that uses the router 50 and that receives the same multicast stream as the client 60, the router 50 replaces the address of the multicast stream; for example, specially, the router 50 replaces the MAC address of the destination by the MAC address of another client while the IP address of the destination remains to be the multicast address of the group that the other client participates in (i.e. the group that the client 60 participates in), and the router 50 delivers the multicast stream to the other client. On the other hand, if there is no other client, the controller 51 deletes the number of the port 541 used by the network 10 from the multicast communication area 521b of the MAC address table 521 and separates from the group.

The router 50 transmits the signal for requesting the unicast stream for special reproduction instructed from the reproduction time stored in the memory 52, to the unicast server 30 on the basis of the unicast address of the unicast server 30 stored in the memory 52 in parallel with the process in the step S509 (step S510). The unicast server 30 which has received the signal generates the requested unicast stream for special reproduction, transmits it to the router 50, and updates the management data table 322 (step S511).

The router 50 replaces the address of the unicast stream received; for example, specifically, the router 50 replaces the MAC address of the destination by the MAC address of the client 60 while the IP address of the destination remains to be the multicast address of the group that the client 60 participates in, and the router 50 transmits the unicast stream only to the client 60. In other words, the router 50 transmits it as the multicast stream in an IP layer and as the unicast stream in a MAC layer (step S512).

The controller 61 of the client 60 reproduces the received unicast stream and displays it on the display 66. Incidentally, as described above, the received unicast stream is the multicast stream in the IP layer, so that the client 60 can receive the stream for special reproduction without any process.

By this, it is possible to perform the special reproduction while watching the content that is delivered by multicasting. In addition, since the router 50 obtains the unicast address in advance, it is possible to switch to the special reproduction, seamlessly. Moreover, since the switching from the multicast delivery to the unicast delivery is performed by the router 50, it is possible to reduce a load of the client 60.

(Returning Process Operation)

Next, with reference to a timing chart in FIG. 20, an explanation will be given on the returning process operation of returning to the multicast delivery in the content delivery system in the embodiment.

In FIG. 20, when the special reproduction is performed on the content (step S512), if the user 70 gives an instruction of the normal reproduction to the client 60 (step S601), the client 60 transmits the signal indicating the normal reproduction to the router 50 (step S602). The router which has received the signal transmits the signal for requesting the unicast stream for normal reproduction, to the unicast server 30 (step S603). The unicast server 30 which has received the signal judges whether or not there is adjacent content (step S604).

If it is judged that there is the adjacent content, the unicast server 30 transmits the signals indicating the time difference from the adjacent content and the multicast address at which the adjacent content can be received, to the router 50 (step S605). The unicast server 30 also generates the unicast stream for normal reproduction, delivers it to the router 50, and updates the management data table 322 (step S606).

On the other hand, if it is judged that there is no adjacent content, the unicast server 30 typically generates the unicast stream for normal reproduction, delivers it to the router 50, and updates the management data table 322.

The controller 51 of the router 50 which has received the signals indicating the time difference and the multicast address since it is judged that there is the adjacent content stores the received time difference and the received multicast address into the memory 52, and the controller 51 also performs the predetermined returning process on the unicast stream such that the time difference between the adjacent content and the unicat stream is eliminated (step S607). The controller 51 also replaces the address of the unicast stream on which the returning process is performed and transmits it to the client 60 (step S608).

In parallel with the returning process, the controller 51 stores the number of the port 521 used for the communication with the network 10 and the MAC address based on the multicast address of the adjacent content, into the multicast communication area 521b of the MAC address table 521, in order to receive the adjacent content (step S609).

If it is judged that the time difference between the adjacent content and the unicast stream is eliminated (step S610), the controller 51 replaces the MAC address stored at the predetermined position 522 in the multicast communication area 521b of the MAC address table 521 by the MAC address based on the multicast address of the adjacent content (step S611), so that the adjacent content is delivered to the client 60 from the multicast server 20 (step S612).

Then, the router 50 transmits the signal indicating the stop of the delivery of the unicast stream, to the unicast server 30 (step S613).

By this, it is possible to return to the multicast delivery again after the special reproduction, thereby reducing the load of the unicast server 30. Moreover, since the return to the multicast delivery is performed by the router 50, it is possible to reduce the load of the client 60.

### Fourth Embodiment

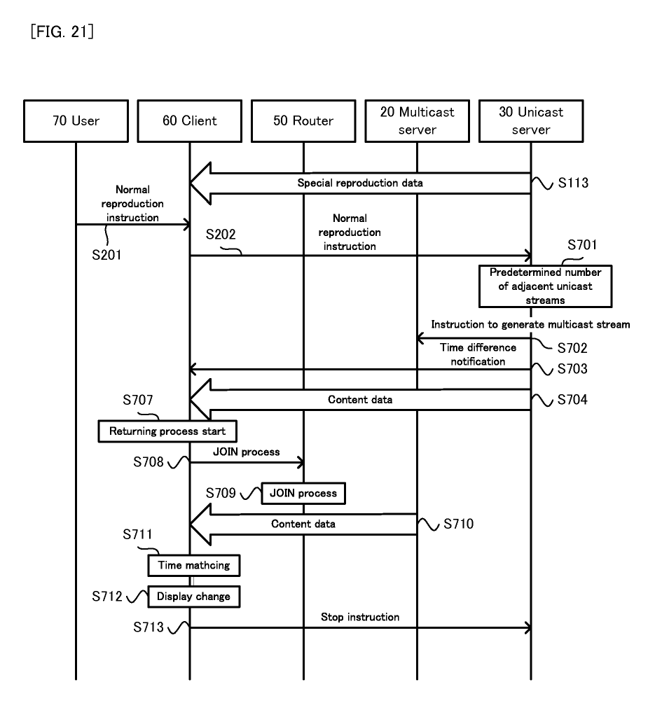

A fourth embodiment of the content delivery system of the present invention will be explained with reference to FIG. 21. The fourth embodiment has the same construction as the first embodiment, apart from having the different returning process operation. Thus, in the fourth embodiment, the repetitive explanation to the first embodiment will be omitted. Common points on the drawings will carry the same referential numerical, and basically different points will be explained with reference to FIG. 21.

(Returning Process Operation)

In FIG. 21, when the special reproduction is performed on the content (step S113), if the user 70 gives an instruction of the normal reproduction to the client 60 (step S201), the client 60 transmits the signal for requesting the unicast stream for normal reproduction, to the unicast server 30 (step S202). The unicast server 30 which has received the signal judges whether or not there are a predetermined number or more of unicast streams at close reproduction positions (e.g. with a time difference of about several seconds) (which is hereinafter referred to as adjacent unicast streams), in one or a plurality of unicast streams for normal reproduction of the same content, which are delivered by the unicast server 30 (step S701). Here, the “predetermined number” is a value set in accordance with the capacities of the unicast server and the multicast server. It is desirably about 10, but it may be 1.

Incidentally, if there are a plurality of unicast servers, the unicast server 30 may judge whether or not there are a predetermined number or more of adjacent unicast streams, in the unicast streams for normal reproduction of the same content which are delivered by each of the plurality of unicast servers.

If there are the predetermined number or more of adjacent unicast streams, the unicast server 30 transmits the signal for requesting the generation of the multicast stream, which is one example of the “multicast stream for return” in the present invention, to the multicast server 20 (step S702). The unicast server 30 also transmits the signals indicating the time difference from the generated multicast stream and the multicast address at which the generated multicast stream can be received, to the client 60 (step S703).

Incidentally, the reproduction position of the generated multicast stream is typically an average value of the reproduction positions of the plurality of adjacent unicast streams; however, it may be the same as the reproduction of an arbitrary adjacent unicast stream.

In parallel with the process in the step S703, the unicast server 30 generates the unicast stream for normal reproduction, delivers it to the client 60, and updates the management data table 322 (step S704).

On the other hand, if it is judged that there are no predetermined number or more of adjacent unicast streams, the unicast server 30 typically generates the unicast stream for normal reproduction, delivers it to the client 60, and updates the management data table 322. Even in this case, if the number of the adjacent unicast streams is greater than or equal to the predetermined number, the process after the step S702 is performed.

Incidentally, even when the unicast stream for normal reproduction from substantially the same reproduction position is requested from a plurality of clients at substantially the same time, the process after the step S702 may be performed.

The controller 61 of the client 60 which has received the signals indicating the time difference and the multicast address since it is judged that there are the predetermined number or more of adjacent unicast streams stores the received time difference and the received multicast address into the memory 62, and the controller 61 also performs the predetermined returning process on the unicast stream such that the time difference between the generated multicast stream and the unicast stream is eliminated (step S707).

In parallel with the returning process, the controller 61 transmits the signal indicating the multicast participation report message for participating in the group that can received the generated multicast stream, to the router 50 (step S709). The router 50 which has received the signal enables the client 60 to participate in the group that can receive the generated multicast stream (step S709), so that the adjacent content is delivered to the client 60 from the multicast server 20 (step S710).

If it is judged that the time difference between the generated multicast stream and the unicast stream is eliminated (step S711), the controller 61 of the client 60 reproduces the generated multicast stream and displays it on the display 66 (step S712).

Then, the client 60 transmits the signal indicating the stop of the delivery of the unicast stream, to the unicast server 30 (step S713).

By this, even if there is no adjacent content to be delivered when it is requested to return to the normal reproduction, it is possible to return to the multicast delivery by generating new adjacent content.

Incidentally, the present invention is not limited to the aforementioned embodiments, but various changes may be made, if desired, without departing from the essence or spirit of the invention which can be read from the claims and the entire specification. A content delivery system, which involves such changes, is also intended to be within the technical scope of the present invention.

1-12. (canceled)

13. A content delivery system comprising:
a content managing device for managing one or a plurality of content;
a multicast delivering device for delivering a multicast stream of the managed content;
a unicast delivering device for delivering a unicast stream of the managed content; and a terminal capable of receiving and reproducing the delivered multicast stream and the delivered unicast stream and also capable of receiving a request for delivery of desired content and a request for special reproduction when the desired content is reproduced, said content managing device transmitting first information for specifying said multicast delivering device and second information for specifying said unicast delivering device to said terminal in response to the received request for delivery, said terminal receiving and reproducing the multicast stream corresponding to the desired content of the delivered multicast stream on the basis of the transmitted first information, said terminal requesting the special reproduction of said unicast delivering device on the basis of the transmitted second information when the request for the special reproduction is received, said unicast delivering device delivering the unicast stream for the special reproduction corresponding to the desired content, to said terminal in response to the request for the special reproduction, said terminal receiving and reproducing the delivered unicast stream for the special reproduction, said multicast delivering device and said unicast delivering device being disposed in a same server apparatus, said unicast delivering device delivering the multicast stream that can be received by a particular terminal as the unicast stream.

14. The content delivery system according to claim 13, wherein said terminal obtains a reproduction position of the multicast stream corresponding to the desired content when the request for the special reproduction is received, and the terminal requests the special reproduction from the obtained reproduction position of said unicast delivering device.

15. The content delivery system according to claim 13, wherein said terminal stops the reception of the multicast stream corresponding to the desired content when the request for the special reproduction is received.

16. A content delivery system comprising:
a content managing device for managing one or a plurality of content;
a multicast delivering device for delivering a multicast stream of the managed content;
a unicast delivering device for delivering a unicast stream of the managed content;
a terminal capable of receiving and reproducing the delivered multicast stream and the delivered unicast stream and also capable of receiving a request for delivery of desired content and a request for special reproduction when the desired content is reproduced; and a router for relaying said terminal to each of said content managing device, said multicast delivering device, and said unicast delivering device, said content managing device transmitting first information for specifying said multicast delivering device and second information for specifying said unicast delivering device to said router in response to the received request for delivery, said router transmitting the multicast stream corresponding to the desired content of the delivered multicast stream, to said terminal on the basis of the transmitted first information, said terminal receiving and reproducing the transmitted multicast stream, said terminal requesting the special reproduction of said router when the request for the special reproduction is received, said router requesting the special reproduction of said unicast delivering device on the basis of the delivered second information when the special reproduction is requested, said unicast delivering device delivering the unicast stream for the special reproduction corresponding to the desired content, to said router in response to the request for the special reproduction, said router transmitting the delivered unicast stream for the special reproduction to said terminal, said terminal receiving and reproducing the transmitted unicast stream for the special reproduction.

17. The content delivery system according to claim 16, wherein said router transmits the delivered unicast stream for the special reproduction to said terminal as the multicast stream.

18. The content delivery system according to claim 16, wherein said router transmits the transmitted first information to said terminal.

19. The content delivery system according to claim 13, wherein said terminal can also receive a request for return to normal reproduction when the special reproduction is performed on the desired content, said terminal requests the return of said unicast delivering device on the basis of the transmitted second information when the request for the return is received, said unicast delivering device includes a judging device for judging whether or not there is the multicast stream for the return at a reproduction position in a predetermined period with respect to a reproduction position of the unicast stream for the special reproduction when the return is requested, said unicast delivering device transmits a time difference between the reproduction positions of the unicast stream for the special reproduction and the multicast stream for the return to said terminal and delivers the unicast stream for the normal reproduction from the reproduction position of the unicast stream for the special reproduction if it is judged that there is the multicast stream for the return, said terminal receives and reproduces the unicast stream for the normal reproduction delivered such that the time difference is eliminated, and said terminal receives and reproduces the multicast stream for the return under a condition that the time difference is eliminated.

20. The content delivery system according to claim 16, wherein said terminal can also receive a request for return to normal reproduction when the special reproduction is performed on the desired content, said terminal requests the return of said router when the request for the return is received, said router requests the return of said unicast delivering device on the basis of the delivered second information when the return is requested, said unicast delivering device includes a judging device for judging whether or not there is the multicast stream for the return at a reproduction position in a predetermined period with respect to a reproduction position of the unicast stream for the special reproduction when the return is requested, said unicast delivering device transmits a time difference between the reproduction positions of the unicast stream for the special reproduction and the multicast stream for the return to said router and delivers the unicast stream for the normal reproduction from the reproduction position of the unicast stream for the special reproduction if it is judged that there is the multicast stream for the return, said router transmits the unicast stream for the normal reproduction to said terminal such that the time difference is eliminated, said terminal receives and reproduces the transmitted unicast stream for the normal reproduction, said router transmits the multicast stream for the return, to said terminal under a condition that the time difference is eliminated, and said terminal receives and reproduces the transmitted multicast stream for the return.

21. The content delivery system according to claim 13, wherein said terminal can also receive a request for return to normal reproduction when the special reproduction is performed on the desired content, said terminal requests the return of said unicast delivering device on the basis of the transmitted second information when the request for the return is received, said unicast delivering device includes a judging device for judging whether or not there are a predetermined number or more of unicast streams at reproduction positions in a predetermined period with respect to a reproduction position of the unicast stream for the special reproduction when the return is requested, said unicast delivering device requests said multicast delivering device to generate the multicast stream for the return if it is judged that there are the predetermined number or more of unicast streams, also transmits a time difference between the reproduction positions of the unicast stream for the special reproduction and the multicast stream for the return, to said terminal, and delivers the unicast stream for the normal reproduction from the reproduction position of the unicast stream for the special reproduction, said terminal receives and reproduces the unicast stream for the normal reproduction delivered such that the time difference is eliminated, said terminal receives and reproduces the multicast stream for the return under a condition that the time difference is eliminated.
